(19) United States
(12) Patent Application Publication
(10) Pub. No.: US 2022/0184555 A1
(43) Pub. Date: Jun. 16, 2022

(54) TDS CREEP SOLUTION FOR PUMPLESS, TANKLESS SYSTEM

(71) Applicant: A. O. SMITH CORPORATION, Milwaukee, WI (US)

(72) Inventor: Haifeng Zhang, Wauwatosa, WI (US)

(21) Appl. No.: 17/440,100

(22) PCT Filed: Apr. 30, 2020
(86) PCT No.: PCT/US2020/030766

§ 371 Date: Sep. 16, 2021

Related U.S. Application Data
(60) Provisional application No. 62/844,545, filed on May 7, 2019.

(51) Int. Cl. B01D 61/12; B01D 61/02; B01D 61/08; C02F 1/44; C02F 1/00

(52) U.S. Cl. CPC B01D 61/12; B01D 61/025; B01D 61/08; C02F 1/441; C02F 1/008; C02F 2201/005; B01D 2313/18; C02F 2209/03; C02F 2209/10; C02F 2307/06; B01D 2313/50

(57) ABSTRACT

A water purification system includes a water inlet for delivering feed water, a membrane having an upstream side and a downstream side, and a water outlet for drawing permeate out of the system. The system includes a plurality of valves operable to control a flow path of feed water, the permeate, and impure water through the system, and a drain in connection with the upstream side and configured to receive the impure water and impurities from the feed water. The system includes a tank configured to receive permeate from the downstream side of the membrane and to store a standby volume of the permeate for delivery to the outlet during an initial portion of a water draw, and a control system for manipulating the plurality of valves.

### CROSS-REFERENCE TO RELATED APPLICATIONS

This application claims priority to U.S. Provisional Patent Application No. 62/844,545, filed on May 7, 2019, the entire contents of which are incorporated by reference herein.

### FIELD OF THE INVENTION

The present invention relates to a water purification system, and more particularly, to a point-of-use water purification system for minimizing TDS creep.

### BACKGROUND

In water purification systems, TDS creep occurs during standby. TDS (e.g., total dissolved solids) creep is a behavior that causes salt ions to diffuse through a reverse osmosis membrane when a reverse osmosis water system is not in use. The behavior may be neglected when pure water is produced. However, TDS creep may cause produced water, post-reverse osmosis membrane to have a high TDS value.

For a system including a holding tank, TDS creep water may be diluted significantly within the tank and the customer will not experience high TDS in water. However, for tankless or high flow systems without a water storage tank, the initial product water after stagnation will have high TDS in comparison to normal RO (e.g., reversed osmosis) production water. For a 50% recovery rate system, the TDS peak can be high up to 60% of the tap water TDS, and for 75% recovery system, the TDS peak value in the product water can be as high as 120% of the tap water TDS level.

In some countries, such as the United States, tap water pressure is relatively high (e.g., 90 psi). In order to reduce the cost on the system, a pump may be eliminated, allowing feed water to move based on pressure differential between tap water and a system outlet. However, when the pump is eliminated, TDS still develops within the system. As such, there is a need for a method to eliminate TDS creep in pumpless, tankless water systems.

### SUMMARY

In one aspect, the invention provides a water purification system including a water inlet for delivering feed water having a first pressure to the system, a membrane having an upstream side and a downstream side and configured to receive feed water on the upstream side and remove impurities from the water as the water migrates across the membrane to the downstream side, water migrating to the downstream side of the membrane being permeate having a concentration of impurities below a threshold level, wherein during a standby period when the inlet is closed, impurities migrate across the membrane from the upstream side to the downstream side to turn the permeate into impure water with a concentration of impurities above the threshold level and a second pressure which is less than the first pressure. A water outlet is provided for drawing permeate out of the system, wherein the second pressure acts as a motive fluid and moves the feed water from the downstream side of the membrane to the water outlet. A plurality of valves are operable to control a flow path of the feed water, the permeate, and the impure water through the system. A drain is in connection with the upstream side and configured to receive the impure water and impurities from the feed water. A tank is configured to receive permeate from the downstream side of the membrane and to store a standby volume of the permeate for delivery to the outlet during an initial portion of a water draw. A control system for manipulating the plurality of valves to use impure water displaced from the downstream side of the membrane as a motive fluid to displace permeate from the tank to the outlet during the initial portion of water draw, the control system manipulating the plurality of valves to dispose of the motive fluid to the drain, the control system refilling the tank to the standby volume of permeate after the end of the water draw.

In another aspect, the invention provides a method of operating a water purification system, the system including a water inlet and a water outlet for respectively delivering feed water to the system and drawing permeate water out of the system during a water draw, a membrane having an upstream side and a downstream side, a tank, and a drain. The method includes directing feed water through the inlet, passing the feed water across the membrane from the upstream side to the downstream side to produce concentrate on the upstream side and permeate on the downstream side, and filling the tank with a standby volume of the permeate. The method further includes during standby, when no water is drawn from the system, closing the inlet and the outlet such that impurities migrate across the membrane from the upstream side to the downstream side to turn the permeate on the downstream side into impure water. The method further includes during the water draw, opening the inlet to receive feed water to initiate movement of the impure water, and using the impure water as a motive fluid to displace permeate from the tank to the outlet during the initial portion of the water draw. The method further includes delivering the motive fluid to the drain and refilling the tank to the standby volume of permeate after the end of the water draw.

Other aspects of the invention will become apparent by consideration of the detailed description and accompanying drawings.

### BRIEF DESCRIPTION OF THE DRAWINGS

FIG. 1A is a schematic representation of a point-of-use water purification system operating in a first mode of operation, at a first step.

FIG. 1B is a schematic representation of the water purification system of FIG. 1A operating in the first mode of operation, at a second step.

FIG. 1C is a schematic representation of the water purification system of FIG. 1A operating in the first mode of operation, at a third step.

FIG. 1D is a schematic representation of the water purification system of FIG. 1A operating in the first mode of operation, at a fourth step.

FIG. 2A is a schematic representation of the water purification system of FIGS. 1A-1D operating in a second mode of operation, at a first step.

FIG. 2B is a schematic representation of the water purification system of FIG. 2A operating in the second mode of operation, at a second step.

FIG. 2C is a schematic representation of the water purification system of FIG. 2A operating in the second mode of operation, at a third step.

FIG. 3 is a representation of a control system for use with the water purification system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

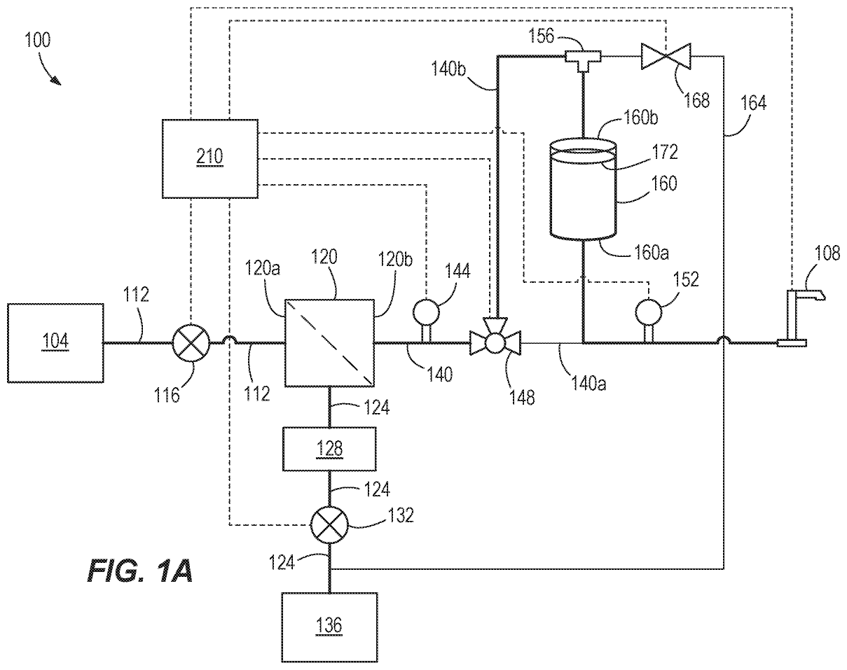

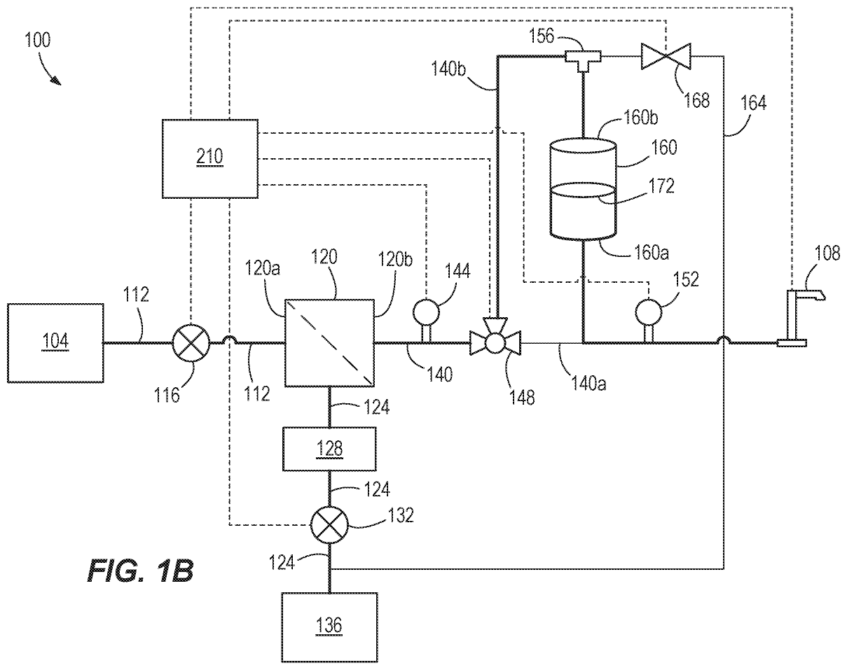

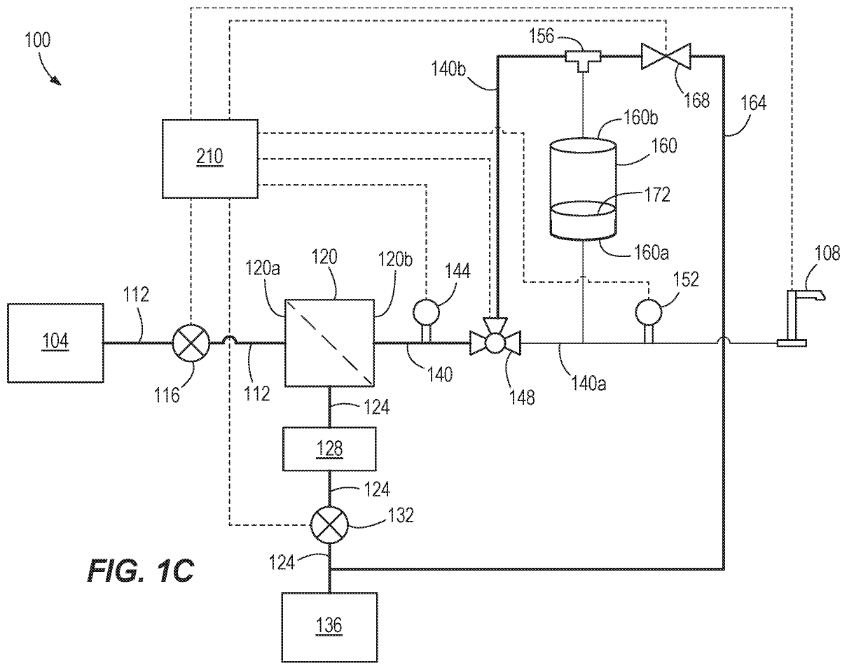

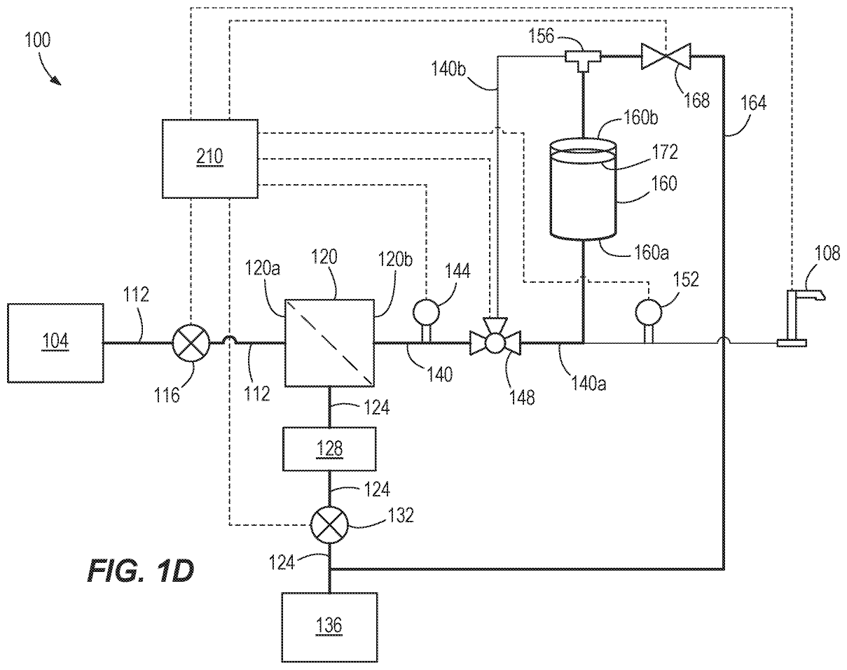

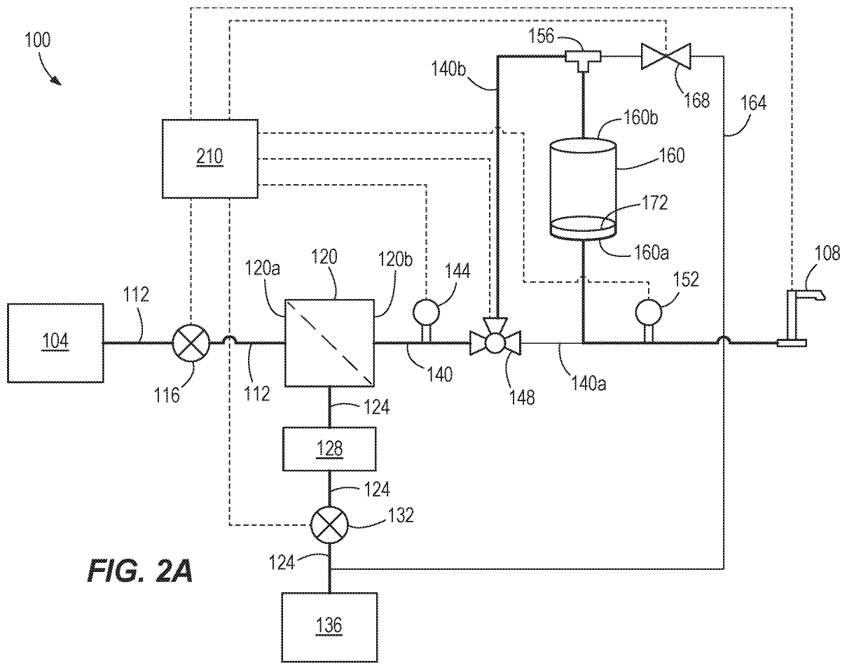

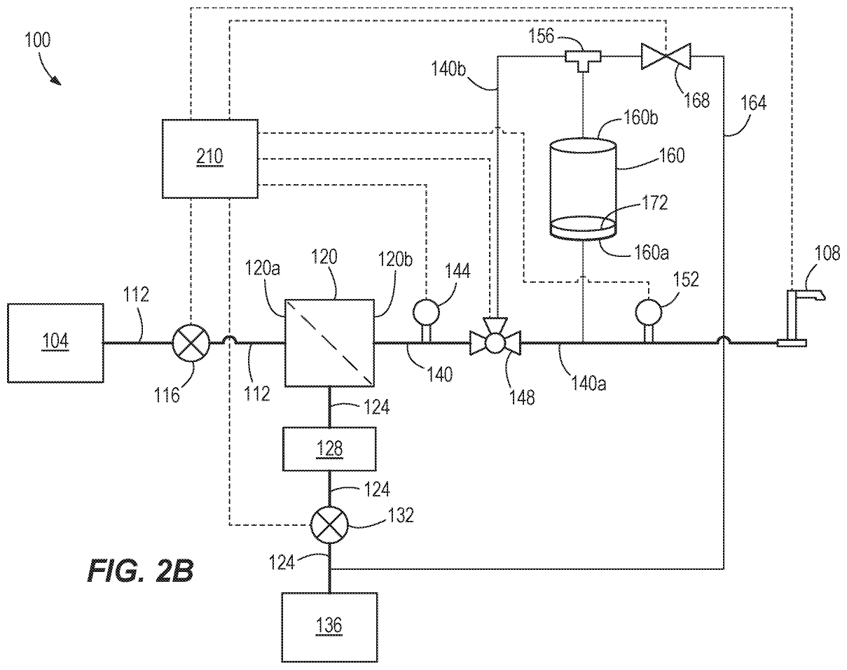

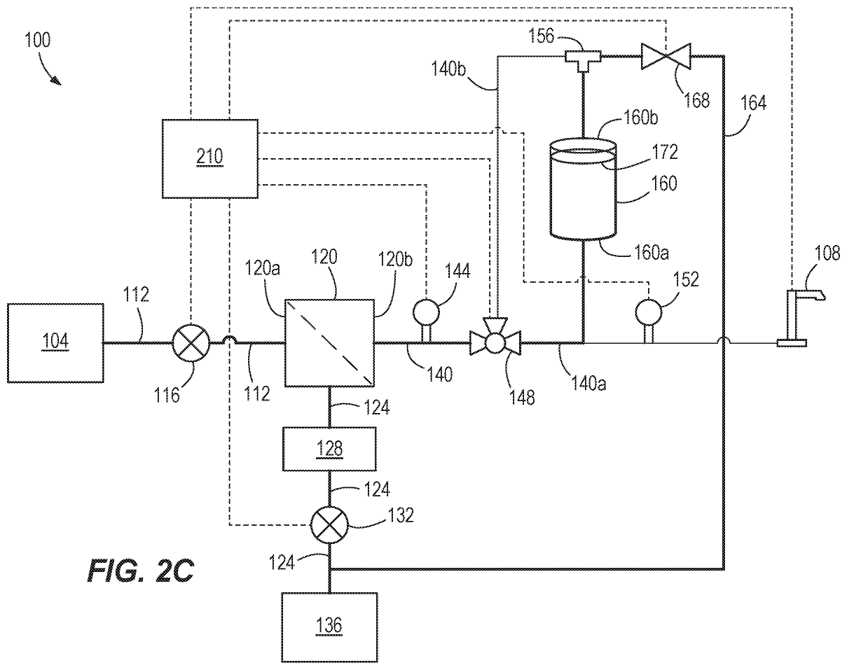

FIGS. 1A-1D and 2A-2C schematically represent a point-of-use pumpless, tankless water purification system 100. A first mode of operation is illustrated in FIGS. 1A-1D and a second mode of operation is illustrated in FIGS. 2A-2C. Before discussing the modes of operation, the components of the system 100 should be understood. The system 100 receives water (called “feed water”) from a water supply 104, which may be a municipal water supply, a well or any other typical source of potable water, and delivers clean, purified water to a potable water output device such as a faucet 108. The feed water may be provided under typical head pressures for water supply systems, this pressure being referred to as “supply pressure.” Specifically, the supply pressure is sufficient for the water to flow through and operate the system 100, as will be described in detail below, without the assistance of a pump. Pressure differential between a downstream side of a membrane 120 and the feed water allows the feed water to move within the system 100. Thus, the feed water acts as a motive force for the system 100, eliminating the need for a pump. The water supply 104 and faucet 108 are illustrated schematically and are intended to include any water inlet and any water outlet for the system 100.

The major components of the system 100 include: a feed line 112, a first solenoid valve 116, the membrane 120, a concentrate line 124, a composite valve 128, a drain valve 132, a drain 136, a permeate line 140, a first sensor 144, a three-way valve 148, a second sensor 152, a bypass tee 156, a tank 160, an exit line 164, an exit valve 168, and a control system 200. The control system 200 includes control logic to coordinate operation of the various other components. The specific control logic will be addressed after the following description of the major components.

The feed line 112 communicates between the supply 104 and the membrane 120. The first solenoid valve 116 is positioned in the feed line 112. When the faucet 104 is opened, a controller 210 in the control system 200 opens the first solenoid valve 116. When open, the first solenoid valve 116 allows feed water to flow from the supply 104 to the membrane 120. The supply pressure is sufficient to move the feed water through the membrane 120.

The membrane 120 includes an upstream side 120a communicating with the feed line 112 and a downstream side 120b communicating with the permeate line 140. The term “membrane” as used herein includes an actual membrane element with or without the surrounding structure such as a membrane canister, as will be clear from the context in which the term is used. Exemplary types of membranes, which may be suitable for the system include without limitation a semi-permeable membrane such as a reverse osmosis (RO) membrane, a nanofiltration membrane, an ultrafiltration membrane, a microfiltration membrane, or another type of membrane suitable for the design parameters of the system 100.

The supply pressure causes the feed water to diffuse across the membrane 120 from the upstream side 120a to the downstream side 120b. Impurities, such as salts and dissolved solids accumulate on the upstream side 120a of the membrane 120. As a result, the water on the upstream side 120a includes a relatively high concentration of impurities and may be referred to as concentrate. The water on the downstream side 120b has a lower concentration of impurities and may be referred to as permeate. The concentration of impurities in the permeate depends on the type of membrane employed, but a threshold concentration of impurities is established for a given membrane and as long as the concentration of impurities is below the threshold the water may be referred to as permeate.

During standby, when the faucet 108 is closed and the controller 210 closes the first solenoid valve 116, impurities will migrate across the membrane 120 from the upstream side 120a to the downstream side 120b. If, during standby, the concentration of impurities in the water on the downstream side 120b exceeds the threshold, the permeate will become impure water.

Effective operation of the membrane 120 often requires that the water flow along the upstream side 120a. The movement of feed water or concentrate along the upstream side 120a of the membrane 120 helps reduce scale formation on the upstream side 120a. The concentrate line 124 communicates with the upstream side 120a to facilitate such water movement. The composite valve 128 is in the concentrate line 124 and includes a flow control valve to maintain a constant flow rate through the concentrate line 124, which also causes a constant flow rate along the upstream side 120a. The drain valve 132 is in the concentrate line 124 and is controlled by the controller 210 to open or close the concentrate line 124 to permit the flow of concentrate to the drain 136 as waste water. The drain valve 132 is normally open during operation in order to facilitate the disposal of concentrate and TDS water. In the illustrated embodiments, the drain valve 132 is a solenoid valve; however, in alternative embodiments, the drain valve 132 may be an alternative type of valve.

The permeate line 140 communicates with the downstream side 120b of the membrane 120. The three-way valve 148 divides the permeate line 140 into an output portion 140a and a bypass portion 140b. The first sensor, or TDS sensor, 144 is in the permeate line 140 downstream of the membrane 120 to monitor impurities (e.g., total dissolved solids) in the permeate line 140 and communicate the impurities to the controller 210. The first sensor 144 may be positioned, for example, immediately downstream of the membrane 120 and upstream of the three-way valve 148 as illustrated.

The output portion 140a of the permeate line 140 communicates between the three-way valve 148 and both a permeate side 160a of the tank 160 and the faucet 108. The second sensor, or pressure sensor, 152 is in the output portion 140a of the permeate line 140. The second sensor 152 monitors and reports to the controller 210 the pressure of water in the output portion 140a of the permeate line 140, which correlates to pressure on the permeate side 160a of the tank 160 and at the faucet 108. The controller 210 may determine whether the faucet 108 is open or closed based on the pressure measured by the second sensor 152. In other configurations of the controller 210, the faucet 108 may generate an electronic signal, which is used to indicate when the faucet 108 is opened and closed, rather than or in addition to using the second sensor 152 for this purpose.

The bypass portion 140b of the permeate line 140 communicates between the three-way valve 148 and the bypass tee 156. The bypass tee 156 places the bypass portion 140b of the permeate line 140, the exit line 164, and a TDS side 160b of the tank 160 into three-way communication. In some embodiments, the bypass portion 140b may include a third sensor, or pressure sensor, positioned between the three-way valve 148 and the bypass tee 156 to monitor and report to the controller 210 the pressure of water in the bypass portion 140b of the permeate line 140, which correlates to pressure on the TDS side 160b of the tank 160.

The exit line 164 communicates between the bypass tee 156 and the concentrate line 124. The exit valve 168 is in the exit line 164 and is controlled by the controller 210 to open and close the exit line 164 to permit or prevent flow of water from the bypass tee 156 to the drain valve 132. In another configuration, which will be understood by those of ordinary skill in the art, the bypass tee 156 and the exit valve 168 can be combined into a single three-way valve at the location of the bypass tee 156. Such a three-way valve would perform the same function as the separate bypass tee 156 and the exit valve 168.

The tank 160 may take the form of any receptacle or vessel which can store permeate during standby and from which permeate can be dispensed through the faucet 108 during an initial portion of a water draw. In this regard, the term “tank” is intended to be a very broad term encompassing all such receptacles and vessels. The tank 160 includes a divider 172 which separates the permeate side 160a from the TDS side 160b. The divider 172, which may take the form of a diaphragm, bladder, piston or any other suitable member, is sealed with respect to the tank wall so that water cannot migrate across it between the permeate side 160a and the TDS side 160b under the pressures expected in the system 100. The permeate side 160a has a capacity referred to as standby volume. The standby volume can be a higher volume than what is expected for relatively short water draws from the faucet 108. Specifically, the standby volume is approximately equal to the volume of water in the membrane 120 with high TDS. Therefore, the system 100 may switch from standby water to membrane-supplied water at the same time that high TDS water is flushed from the system 100 and the membrane-supplied water is at a desired quality. In the example below, the standby volume is 600 mL.

The standby volume is sufficient to satisfy short water draws immediately following a standby period. As will be discussed, the permeate side 160a of the tank 160 is filled to the standby volume with permeate during system setup and after every draw from the faucet 108. Thus the standby volume of permeate is maintained on the permeate side 160a during standby periods. A standby period occurs when the faucet 108 is closed and the first solenoid valve 116 is closed such that supply water is prevented from entering the system 100.

With particular reference to FIGS. 1A-1D, a first mode of operation of the system 100 (in which the user draws less than the standby volume of the tank 160) will now be described. In these illustrations, the conduits having water flow are depicted with thicker lines than the conduits with no water flow. During a standby period of the system 100, the faucet 108 is closed and the first solenoid valve 116 is closed, thus preventing feed water from entering the system 100. The permeate side 160a of the tank 160 contains the standby volume of permeate (e.g., 600 mL in the present example), the drain valve 132 is open, and the other valves (i.e., the faucet 108 and exit valve 168) are closed. As noted above, during the standby period, impurities creep across the membrane 120 from the upstream side 120a to the downstream side 120b, with the result of total dissolved solids (“TDS”) on the downstream side 120b potentially exceeding the threshold level at which the permeate becomes “impure water” or “TDS creep water.”

FIG. 1A illustrates the system 100 at the beginning of the initial portion of the water draw from the faucet 108, immediately after a standby period. The term “initial period of water draw” means the portion, usually expressed in terms of volumetric flow, necessary to flush the downstream side 120b of the membrane 120 of impurities such that the water on the downstream side 120b is permeate. The instant that the faucet 108 is open, the controller 210 senses a pressure drop at the pressure sensor 152 (or receives another signal indicative of the faucet 108 opening) and opens the first solenoid valve 116. The feed water flows under supply pressure across the membrane 120. The controller 210 senses a TDS value over a threshold value for permeate (i.e., that the water is impure water) at the TDS sensor 144 and configures the three-way valve 148 to direct water only to the bypass line 140b. Thus, impure water is directed toward the bypass portion 140b of the permeate line 140. Impure water on the downstream side 120b of the membrane 120 is forced under through the bypass portion 140b of the permeate line 140 and into the TDS side 160b of the tank 160. This impure water acting under the influence of system water pressure (which is supply pressure minus any pressure drop across the membrane 120 and minus any other pressure drop arising in the system) may be referred to as “motive fluid.” At the same time that impure water is being pushed through the bypass line 140b, concentrate flows out of the upstream side 120a of the membrane 120, through the composite valve 128 and the concentrate line 124, and to the drain 136 via the drain valve 132.

FIG. 1B illustrates an intermediate moment during a water draw while the faucet 108 is open. The motive fluid on the TDS side 160b of the tank 160 deflects the divider 172 to displace permeate stored on the permeate side 160a of the tank 160 through the output portion 140a of the permeate line 140 and out of the faucet 108. The system water pressure is therefore sufficient to deflect the divider 172 without the assistance of a pump. At the moment captured in FIG. 1B, for example, approximately half (i.e., 300 mL in the example) of the standby volume has been forced out of the permeate side 160a of the tank 160 and delivered through the faucet 108 (e.g., to a receptacle such as a drinking glass). The concentrate line 124 functions as noted above, with the composite valve 128 regulating the flow rate, the concentrate being disposed of through the drain 136.

In FIG. 1C, the controller 210 determines that the faucet 108 has been closed when pressure increases at the pressure sensor 152. In some embodiments, a signal from the faucet 108 may additionally or alternatively indicate that the faucet 108 has been closed. In the present example, about two-thirds of the standby volume (i.e., about 400 mL) has been forced out of the tank 160 at the moment captured in FIG. 1C. The controller 210 opens the exit valve 168 and the first solenoid valve 116 remains open to supply 104. The feed water moves, under system pressure, through the membrane 120, through the bypass portion 140b of the permeate line 140, into the exit line 164, and to the drain 136. This continues until the controller 210 senses via the TDS sensor 144 that the membrane 120 is producing permeate. More specifically, the TDS sensor 144 continuously senses the TDS value of water on the downstream side 120b of the membrane 120 and communicates the TDS value to the controller 210. The water in the downstream side 120b is considered permeate when the TDS value us lower than a predetermined threshold. In some embodiments, a timer may be used to estimate when the high TDS water has been flushed from the system 100. Once the controller 210 determines that the TDS value is less than a predetermined threshold value, the controller 210 configures the three-way valve 148 to direct water only the output portion 140a. Thus, water is redirected to flow through the output portion 140a. In alternative embodiments, the controller 210 may redirect the flow of water based on a predetermined number of cycles, predetermined period of time, etc. The concentrate line 124 functions as noted above, with the composite valve 128 regulating the flow rate and the concentrate being disposed of through the drain 136.

FIG. 1D illustrates the process after the controller 210 has determined that the membrane 120 is producing permeate out the downstream side 120b. The controller 210 opens the three-way valve 148 toward the output portion 140a, and the first solenoid valve 116 remains open to the supply 104. The feed water moves through the membrane 120 to produce permeate, but the permeate is now directed into the output portion 140a of the permeate line 140. Because the faucet 108 is closed, backpressure develops in the output portion 140a and permeate enters the permeate side 160a of the tank 160 to recharge or refill the permeate side 160a with permeate. Recharging or refilling the permeate side 160a includes deflecting the divider 172 upwardly as illustrated and is accomplished using system pressure without any assistance from a pump. The controller 210 determines that the permeate side 160a has been refilled to the standby volume when the pressure sensor 152 reaches a predetermined backpressure in the output portion 140a. The controller 210 then closes the first solenoid valve 116 and the system 100 is in standby. Therefore, in the first mode of operation, the controller 210 causes supply water to displace TDS creep water from the membrane 120 and TDS creep water is used as the motive fluid for pushing permeate stored in the tank 160 out of the tank 160 and to the faucet 108. Also in the first mode, permeate is used as the motive fluid to refill the tank 160 with permeate for the next water draw.

With reference now to FIGS. 2A-2C, a second mode of operation of the system 100, in which the user draws more than the standby volume will now be described. As with the discussion above, the lines representing water conduits under pressure or with water flow are made thicker for illustration purposes.

FIG. 2A illustrates the system 100 in a similar condition to FIGS. 1A and 1B above (faucet 108, drain valve 132, and first solenoid valve 116 open and the three-way valve 148 is open to the bypass portion 140b of the permeate line 140), except that the water draw has continued until the standby volume (e.g., 600 mL) has been fully depleted. As with the first mode, the motive fluid is impure water acting under system pressure (supply pressure minus pressure drops in the system) and without the assistance of a pump. At this moment, the divider 172 has reached its maximum deflection and backpressure accumulates in the bypass portion 140b of the permeate line 140. The volume of motive fluid required to fully deflect the divider 172 and fully deplete the standby volume should be sufficient to also adequately flush the membrane 120 of impure water. If the membrane 120 is adequately flushed of impure water, it will be producing permeate on the downstream side 120b by the time the standby volume has been fully depleted, as illustrated in FIG. 2A.

In FIG. 2B, the controller 210 has recognized the permeate with the TDS sensor 144 and has redirected the three-way valve 148 to guide water to the output portion 140a of the permeate line 140. In alternative embodiments, the controller 210 may detect backpressure in the bypass portion 140b via a pressure sensor positioned in the bypass portion 140b. It will be appreciated that any water on the downstream side 120b of the membrane 120 will immediately be delivered to the faucet 108, which is why it is desirable that the standby volume be selected such that the volume of motive fluid to fully deplete the standby volume be sufficient to fully flush the membrane 120 as noted above. The membrane 120 and tank 160 may be sized and configured, for example, such that the volume of motive fluid required to fully deplete the standby volume in the tank 160 and fully flush the membrane 120 is equal to the standby volume. The system 100 can run in the configuration of FIG. 2B as long as water is demanded at the faucet 108. The feed water continuously flows through the membrane 120 under supply pressure and to the faucet 108 through the output portion 140a of the permeate line 140 under system pressure without the need for a pump until the faucet 108 is closed.

FIG. 2C illustrates the permeate side 160a of the tank 160 being refilled after the faucet 108 has been closed. In response to the faucet 108 being closed, the controller 210 configures the system 100 the same way described above with respect to FIG. 1D. The feed water moves through the membrane 120 under system pressure to produce permeate, and the permeate is still directed into the output portion 140a of the permeate line 140. Because the faucet 108 is closed, backpressure develops in the output portion 140a and permeate enters the permeate side 160a of the tank 160. The controller 210 determines that the permeate side 160a has been refilled to the standby volume when the pressure sensor 152 reaches a predetermined backpressure in the output portion 140a. The tank 160 is therefore refilled with permeate under system pressure without a pump. Any excess permeate directed into the tank 160 may be directed to the drain 136 via the exit line 164. The controller 210 then closes the first solenoid valve 116 and the system 100 is in standby. Therefore, in the second mode of operation, the controller 210 causes supply water to displace TDS creep water from the membrane 120, therefore producing permeate which can be delivered to the faucet 108 when the draw exceeds the capacity of the tank 160.

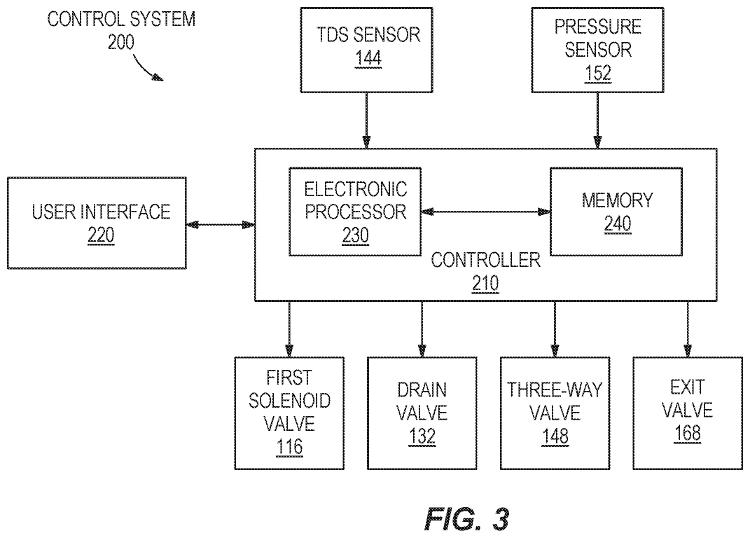

Referring now to FIG. 3, the control system 200 includes the controller 210 and an optional user interface 220. According to one or more exemplary constructions, the controller 210 includes a plurality of electrical and electronic components that provide power, operational control, and protection to the components and modules within the controller 210. For example, the controller 210 includes, among other things, an electronic processor 230 (e.g., a microprocessor, a microcontroller, or another suitable programmable device) and a memory 240. The controller 210 may communicate with various input units such as the TDS sensor 144, the pressure sensor 152, etc. and various output units such as the first solenoid valve 116, the drain valve 132, the three-way valve 148, the exit valve 168, etc.

The memory 240 includes, for example, a program storage area and a data storage area. In some constructions, the memory 240 may be storage space in the cloud. The program storage area and the data storage area can include combinations of different types of memory, such as read-only memory (“ROM”), random access memory (“RAM”) (e.g., dynamic RAM (“DRAM”), synchronous DRAM (“SDRAM”), etc.), electrically erasable programmable read- only memory (“EEPROM”), flash memory, a hard disk, an SD card, or other suitable magnetic, optical, physical, or electronic memory devices. The electronic processor 230 is connected to the memory 240 and executes software instructions that are capable of being stored in RAM (e.g., during execution), ROM (e.g., on a generally permanent basis), or another non-transitory computer readable medium such as another memory or a disc. Software included in the implementation of the system 100 can be stored in the memory 240 of the controller 210. The software includes, for example, firmware, one or more applications, program data, membranes, rules, one or more program modules, and other executable instructions. The controller 210 retrieves from memory 240 and executes, among other things, instructions related to the control processes and methods described herein. In other constructions, the controller 210 includes additional, fewer, or different components.

The optional user interface 220 may be used to control or monitor the system 100. The user interface 220 includes a combination of digital and analog input or output devices required to achieve a desired level of control and monitoring for the system 100. For example, the user interface 220 includes a display (e.g., a primary display, a secondary display, etc.) and input devices such as touch-screen displays, a joystick, a plurality of knobs, dials, switches, buttons, etc. The display is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin- film transistor (“TFT”) LCD, etc. The user interface 220 can also be configured to display conditions or data associated with the system 100 in real-time or substantially real-time. For example, the user interface 220 is configured to display measured electrical characteristics of the system 100 and the status of the system 100. In some implementations, the user interface 220 is controlled in conjunction with the one or more indicators (e.g., LEDs, speakers, etc.) to provide visual or auditory indications of the status or condition of the system 100. The optional user interface 220 may be a smartphone running an application configured to communicate with the control system 200.

Various features and advantages of the disclosure are set forth in the following claims.

What is claimed is:

1. A water purification system comprising:
a water inlet for delivering feed water having a first pressure to the system;
a membrane having an upstream side and a downstream side and configured to receive feed water on the upstream side and remove impurities from the water as the water migrates across the membrane to the downstream side, water migrating to the downstream side of the membrane being permeate having a concentration of impurities below a threshold level, wherein during a standby period when the inlet is closed, impurities migrate across the membrane from the upstream side to the downstream side to turn the permeate into impure water with a concentration of impurities above the threshold level and a second pressure which is less than the first pressure;
a water outlet for drawing permeate out of the system, wherein the second pressure acts as a motive fluid and moves the feed water from the downstream side of the membrane to the water outlet;
a plurality of valves operable to control a flow path of the feed water, the permeate, and the impure water through the system;
a drain in connection with the upstream side and configured to receive the impure water and impurities from the feed water;
a tank configured to receive permeate from the downstream side of the membrane and to store a standby volume of the permeate for delivery to the outlet during an initial portion of a water draw; and
a control system for manipulating the plurality of valves to use impure water displaced from the downstream side of the membrane as a motive fluid to displace permeate from the tank to the outlet during the initial portion of water draw, the control system manipulating the plurality of valves to dispose of the motive fluid to the drain, the control system refilling the tank to the standby volume of permeate after the end of the water draw.

2. The water purification system of claim 1, further comprising a first sensor in connection with the downstream side of the membrane, wherein the first sensor is operable to monitor impurities on the downstream side of the membrane and communicate the impurities to the control system.

3. The water purification system of claim 1, further comprising a second sensor in connection with the downstream side of the membrane, wherein the second sensor is operable to monitor pressure on the downstream side of the membrane and communicate the pressure to the control system.

4. The water purification system of claim 1, wherein the tank includes a divider which separates the permeate from the impure water.

5. The water purification system of claim 1, wherein the standby volume is equal to a volume of impure water in the membrane during the standby period.

6. The water purification system of claim 5, wherein the system is operable in a first mode, wherein the water draw is a first volume of water that is less than or equal to the standby volume, and a second mode, wherein the water draw is a second volume of water that is greater than the standby volume.

7. The water purification system of claim 6, wherein the controller is configured to direct supply water to the membrane to displace the impure water out of the downstream side of the membrane.

8. The water purification system of claim 7, wherein in the first mode, after the water outlet is closed, the impure water is directed from the downstream side of the membrane to the drain until the impure water is removed from the membrane.

9. The water purification system of claim 7, wherein in the second mode, the controller is configured to direct the permeate from the downstream side of the membrane to the water outlet after the water draw exceeds the standby volume.

10. The water purification system of claim 1, wherein the plurality of valves includes a first valve positioned upstream of the membrane, a second valve positioned downstream of the membrane, and a third valve in connection with the drain.

11. The water purification system of claim 10, wherein the third valve is configured to remain open during operation of the system.

12. A method of operating a water purification system, the system including a water inlet and a water outlet for respectively delivering feed water to the system and drawing permeate water out of the system during a water draw, a membrane having an upstream side and a downstream side, a tank, and a drain, the method comprising:
directing feed water through the inlet;
passing the feed water across the membrane from the upstream side to the downstream side to produce concentrate on the upstream side and permeate on the downstream side;
filling the tank with a standby volume of the permeate;
during standby when no water is drawn from the system, closing the inlet and the outlet such that impurities migrate across the membrane from the upstream side to the downstream side to turn the permeate on the downstream side into impure water;
during the water draw, opening the inlet to receive feed water to initiate movement of the impure water;
using the impure water as a motive fluid to displace permeate from the tank to the outlet during the initial portion of the water draw;
delivering the motive fluid to the drain; and
refilling the tank to the standby volume of permeate after the end of the water draw.

13. The method of claim 12, wherein the standby volume is equal to a volume of impure water in the membrane during the standby period.

14. The method of claim 12, further comprising operating the system in a first mode in response to a volume of the water draw being less than or equal to the standby volume of the permeate.

15. The method of claim 14, further comprising, after the water outlet is closed, directing the impure water from the downstream side of the membrane to the drain until the impure water is removed from the membrane.

16. The method of claim 14, further comprising operating the system in a second mode in response to the volume of the water draw being greater than the standby volume of the permeate.

17. The method of claim 16, further comprising directing the permeate from the downstream side of the membrane to the water outlet after the water draw exceeds the standby volume.

18. The method of claim 12, further comprising monitoring impurities on the downstream side of the membrane via a first sensor.

19. The method of claim 12, further comprising monitoring pressure on the downstream side of the membrane via a second sensor.

20. The method of claim 12, further comprising separating the tank via a divider into a first side configured to hold the permeate, and a second side configured to hold the impure water.
